(19) United States
(12) Patent Application Publication
(10) Pub. No.: US 2020/0143988 A1
(43) Pub. Date: May 7, 2020

(54) THERMALLY CONDUCTIVE, ELECTRICALLY INSULATING FILLER FOR COILED WIRES

(71) Applicant: SABIC GLOBAL TECHNOLOGIES B.V., Bergen op Zoom (NL)

(72) Inventors: Yuming XIE, Lexington, KY (US); Ihab Nizar ODEH, Sugar Land, TX (US); Saad Nasser AL-HUSSAIN, Houston, TX (US)

(21) Appl. No.: 16/632,020

(22) PCT Filed: Jul. 18, 2018
(86) PCT No.: PCT/US2018/042577

§ 371 Date: Jan. 17, 2020

Related U.S. Application Data
(60) Provisional application No. 62/534,266, filed on Jul. 19, 2017.

(51) Int. Cl. H01F 41/12; H01F 27/32; H01B 3/30; C08K 3/04; C08K 3/38

(52) U.S. Cl. CPC H01F 41/127; H01F 27/327; H01B 3/305; C08K 2201/011; C08K 3/042; C08K 3/38; C08K 2003/382; H01B 3/306

(57) ABSTRACT

A filler composition includes fully or partially oxidized graphene or boron nitride nano sheets and a thermal setting polymer matrix. The fully or partially oxidized graphene or boron nitride nano sheets are embedded within the polymer matrix, and the filler composition: (i) has a thermal conductivity greater than or equal to 3 W/mK; (ii) has an electric breakdown voltage greater than or equal to 10 kV/mm; (iii) is pourable; and (iv) is located between an electromagnetic wire of an electromagnetic coil. The filler composition can also include the nano sheets bound to the surfaces of a plurality of co-particles that can increase the thermal conductivity through the filler. The polymer matrix can be a polyester imide, a polyamide-imide, polysulfones, a polyimide, a polyether ketone, or combinations thereof.

### FIELD OF THE DISCLOSURE

Thermally conductive and electrically insulating materials can be used as a filler material between enamel-coated electromagnetic wires. The filler materials can include nano sheets dispersed in a polymer matrix that are thermally conductive and electrically insulating.

### BACKGROUND OF THE DISCLOSURE

An electromagnetic coil includes an electrical conductor, such as a wire, wound in various configurations of a coil, spiral, or helix. Electromagnetic coils can be used in devices such as electric motors, inductors, electromagnets, transformers, and sensor coils. Either an electric current is passed through the wire of the coil to generate a magnetic field, or conversely an external time-varying magnetic field through the interior of the coil generates voltage within the conductor. Thermally conductive and electrically insulating polymeric materials are highly desirable for creating an enamel coating on wires of electromagnetic coils.

Removing heat from the electric coils by thermal conduction has been proven to make these devices operate more efficiently, at higher outputs, or provide longer service life. Conventional coating materials are typically polymer composites with ceramics embedded within the polymer due to the low thermal conductivity of polymers. The ceramic materials, especially non-oxides, are generally better thermal conductors than the polymer materials due to their crystalline structure and the characteristics of chemical bonds. In order to improve the thermal conductivity of the polymer, the typical volume fraction of filler needs to be 50 volume percent (vol %) of the polymer or higher. However, issues can arise with such a high concentration of filler, for example, the polymer coating's pliability suffers greatly as the concentration of filler increases.

The thermal conductivity of a material includes two components—electric conduction and phonon transport. As a dielectric material, organic polymers conduct heat through either propagation of anharmonic elastic waves in the continuum or the interaction between quanta of thermal energy called phonons. The major process giving rise to a finite thermal conductivity and energy dissipation from thermal elastic waves is phonon-phonon interaction corresponding to phonon scattering. In addition to phonon-phonon interactions, limited lattice frameworks in the polymer system give significant rise to anharmonicities and results in high phonon scattering, which shortens the free-mean path the phonons are able to travel. This reduction in the free-mean path of the phonons thereby reduces thermal conductivity. As a result, some polymers possess a low thermal conductivity, generally in a range of 0.1 to about 0.5 W/mK, mainly as a result from the random structure of the polymers.

In order to improve the thermal conductivity of polymers, one common approach is to add a thermally conductive ceramic powder, commonly called thermal conductive filler. The thermal conductivity of ceramic-polymer composites generally increases very shallowly with increased concentration of the ceramics. Only when the concentration reaches the percolation limit of about 70 vol %, can significant thermal conductivity increases materialize. The thermal conductivity in such a case can be increased by almost 50 times compared to lower filler concentrations, with a total thermal conductivity reaching above 10 W/mK or more. In addition to a high thermal conductivity, the polymer-filler composites should have a capability to flow, so the space between magnet wires can be filled without any voids for more efficient thermal conduction. However, with such a high ceramic loading, the polymer composites have higher viscosity and slower flow behavior, so their use as encapsulates for electromagnetic wires is generally impractical or impossible.

In addition to a high thermal conductivity and pliability, the encapsulant should also possess a low electrical conductivity; thereby, limiting electron transfer through the encapsulant and increasing the electrical output of the coil. In another approach, more thermally conductive graphene or graphite has been used. The thermal conductivity with graphene or graphite can be increased to 25 W/mK while keeping the polymer composite fairly flexible. However, the electrical conductivity is too high for use as an electrically insulating encapsulate of electromagnetic wires due to the high electron mobility in graphene or graphite.

Other thermally-conductive fillers have also been used to increase the thermal conductivity of an encapsulant for wires. However, these other fillers also suffer from drawbacks of increased electrical conductivity, decreased pliability, or being expensive. Therefore, there is a need for increasing the thermal conductivity away from an electromagnetic wire, while decreasing the electrical conductivity.

A filler can be added between enamel-coated electromagnetic wires. The filler can fill the voids or spaces between the coated wires. This filler can increase the thermal conductivity and decrease electrical conductivity—especially for wires that are coated with an inferior coating, as discussed above.

These and other shortcomings are addressed by aspects of the disclosure.

### SUMMARY

Aspects of the disclosure relate to a filler composition comprising: fully or partially oxidized graphene or boron nitride nano sheets; and a thermal setting polymer matrix. The fully or partially oxidized graphene or boron nitride nano sheets are embedded within the polymer matrix, and the filler composition: (i) has a thermal conductivity greater than or equal to 3 W/mK; (ii) has an electric breakdown voltage greater than or equal to 10 kV/mm; (iii) is pourable; and (iv) is located between an electromagnetic wire of an electromagnetic coil.

Aspects of the disclosure further relate to a method of forming a filler composition comprising: forming fully or partially oxidized graphene or boron nitride nano sheets; combining a first monomer and a second monomer to form a thermal setting polymer matrix; causing or allowing the fully or partially oxidized graphene or boron nitride nano sheets to be dispersed throughout the thermal setting polymer matrix; and applying the filler composition between an electromagnetic wire of an electromagnetic coil. The composition: (i) has a thermal conductivity greater than or equal to 3 W/mK; (ii) has an electric breakdown voltage greater than or equal to 10 kV/mm; and (iii) is pourable.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a graph of thermal conductivity in units of watts per meter-Kelvin (W/mK) versus boron nitride filler volume fraction in units of volume percent (vol %).

FIG. 2 is a schematic of ceramic-coated graphene nano sheets according to certain aspects.

FIG. 3 is a schematic of graphene nano sheets surrounding a co-particle according to certain aspects.

FIG. 4 is a schematic of a composite coating for a filler between electromagnetic wires according to certain aspects.

### DETAILED DESCRIPTION

It has been discovered that a thermally conductive and electrically insulating filler composition can be formed with nano sheets dispersed within a thermally conductive polymer matrix. The composition can be used as a filler between enamel-coated electromagnetic wires. The concentration of the nano sheets can be less than other compositions, while still providing a desired thermal conductivity, electrical insulation, and pliability.

It is to be understood that the discussion of preferred aspects regarding the composition is intended to apply to all of the composition and method aspects.

According to certain aspects, a composition comprises: fully or partially oxidized graphene or boron nitride nano sheets; and a thermal setting polymer matrix, wherein the fully or partially oxidized graphene or boron nitride nano sheets are embedded within the polymer matrix, and wherein the composition: (i) has a thermal conductivity greater than or equal to 3 W/mK; (ii) has an electric breakdown voltage greater than or equal to 10 kV/mm; and (iii) is pourable.

According to certain other aspects, a method of forming a composition comprises: forming fully or partially oxidized graphene or boron nitride nano sheets; combining a first monomer and a second monomer to form a thermal setting polymer matrix; and causing or allowing the fully or partially oxidized graphene or boron nitride nano sheets to be dispersed throughout the thermal setting polymer matrix, wherein the composition: (i) has a thermal conductivity greater than or equal to 3 W/mK; (ii) has an electric breakdown voltage greater than or equal to 10 kV/mm; and (iii) is pourable.

The composition can be used as a filler to fill the voids or spaces between an electromagnetic wire of a coil. The coil can be used in electric motors, inductors, electromagnets, transformers, and sensor coils for example. An electrical current can pass through the wire. A typical current for such a wire can be 3 amp/mm² or greater of wire cross section area. The wire can be un-coated or coated, for example, with an enamel coating. The filler composition can fill the voids or spaces between the wound wire of the coil.

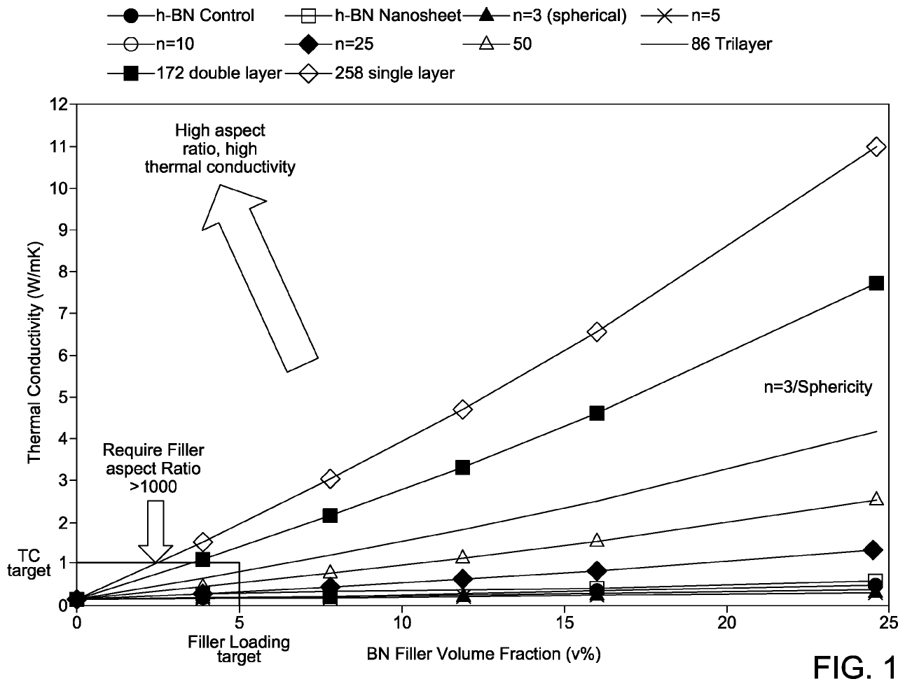

The composition includes fully or partially oxidized graphene or boron nitride nano sheets (BNNS). The nano sheets can be exfoliated to form a single layer of nano sheets compared to non-exfoliated nano sheets, which can be several layers thick. As can be seen in FIG. 1, the 258 single layer BNNS provides the highest thermal conductivity at the same concentration compared to double or multi-layer nano sheets. According to certain other aspects, the nano sheets provide a thermal conductivity of at least 3 watt per meter Kelvin (W/mK). Accordingly, the concentration of the nano sheets can be selected to provide a thermal conductivity greater than or equal to 3 W/mK. The concentration of the nano sheets can also be selected to provide the desired amount of pliability for the filler composition. According to certain aspects, the nano sheets are in a concentration in the range of about 1% to about 25% by volume of the composition.

The methods include forming fully or partially oxidized graphene or boron nitride nano sheets. The methods can further include exfoliating the nano sheets. As used herein, “exfoliated nano sheets” means graphene or boron nitride in the form of a sheet (i.e., a flat artifact that is thin relative to its length and width), with length and width dimensions in the range of about 10 to about several thousands of nanometers (nm) and a height in the range of about 1 to about 50 nm, and a monolayer (i.e., a single sheet). The exfoliated nano sheets can be formed by any suitable method known to those skilled in the art. An illustrated example of formation of the exfoliated nano sheets can include dispersing graphene or boron nitride powder in a polar organic solvent such as N-methylpyrrolidone (NMP), dimethylformamide (DMF), dimethylacetamide (DMAc), dimethyl sulfoxide (DMSO), isopropanol, etc. The slurry is then pumped through a wet jet mill for exfoliation. The slurry can be pressurized at a sufficient pressure (e.g., up to 36,000 pounds force per square inch (psi)) and then released to a single nozzle chamber to form the exfoliated nano sheets. It is to be understood that not all of the graphene or boron nitride powder may form exfoliated nano sheets. Accordingly, the slurry can be cycled as many times as needed to achieve a desired percent conversion. According to certain aspects, the desired percent conversion is at least 30%, more preferably at least 50% or greater. The exfoliated nano sheets can be separated from the polar organic solvent via centrifugation, for example, at revolutions per minute (rpm) in the range of about 5,000 to about 10,000 and a time in the range of about 30 minutes to about 2 hours.

The methods can include fully or partially oxidizing the surface of graphite powder, boron nitride (BN) powder, graphene nano sheets, or BBNS prior to the step of exfoliating the nano sheets. The powders can be oxidized, for example, by mixing the powders, having a particle size of about 0.1 to about 10 micrometers (μm) with a hydrogen peroxide solution, which is a known process for forming hydroxyl groups on the surface of the powders. After stirring for a desired period of time, preferably at room temperature, the slurry is filtered and washed with water under vacuum. The powder can be dried in a vacuum oven at approximately 120° C. for a period of time and then optionally exfoliated.

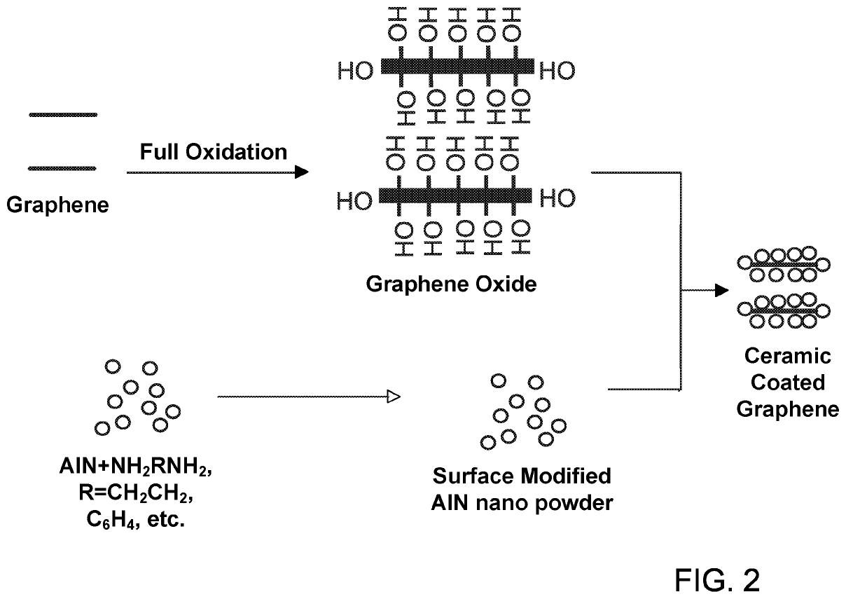

As shown in FIG. 2, graphene sheets can be fully oxidized to form graphene oxide nano sheets. The graphene sheets can be fully oxidized by the Hummers method, or modified Hummers Method, which includes a mixture of graphite and NaNO₃ and H₂SO₄ is stirred in an ice bath (0-5 degrees Celsius (° C.)) for half of an hour. Then KMnO₄ can be added over a period of 2 hours. Water is added gradually and the temperature is raised to 90° C., then 150 milliliters of 1% H₂O₂ is added. The material is washed with 0.1 M HCl and deionized water and collected after drying.

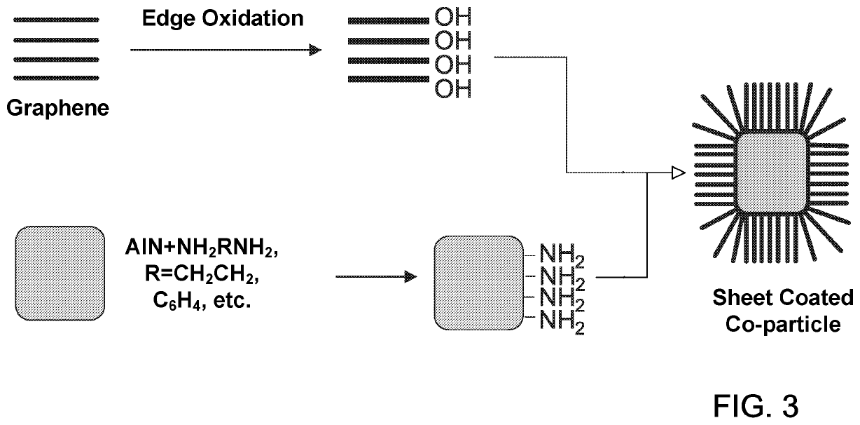

As shown in FIG. 3, graphene sheets can be partially oxidized to result in edge-oxidized graphene nano sheets. The graphene sheets can be partially, edge-oxidized by adding 0.015 M KMnO₄ in 50% H₂SO₄ at a ratio of 1:1 at 60° C. The fully exfoliated graphene sheets can be immersed in the solution for various periods of time. After partial oxidation, the graphene sheets can be collected by centrifugation followed by washing with deionized water.

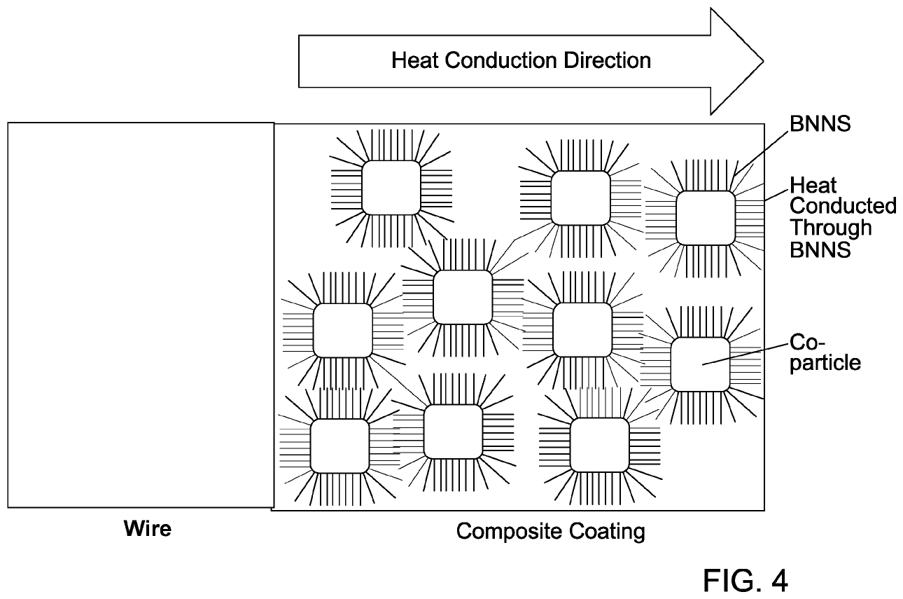

The methods can further include adding a stabilizer prior to or after the step of fully or partially oxidizing the nano sheets. If the nano sheets are exfoliated, then the stabilizer can be added during the step of exfoliation. The stabilizer can help keep the monolayer nano sheets separated and suspended without recombination into multi-layer stacks of sheets. According to certain aspects, the stabilizer is a diamine. Examples of suitable stabilizers include, but are not limited to, 4,4′-methylenedianiline and methylene diphenyl diisocyanate. The stabilizer can chemically react with and form bonds on functional groups on the surface or at the edges of the fully or partially oxidized graphene or boron nitride nano sheets in order to separate and disperse the nano sheets in solution. The diamine stabilizer can also be a first monomer for forming the polymer matrix. The stabilizer can also help form bridges between the edges of the nano sheets. These bridges can help increase heat transfer away from the wire, for example, as shown in FIG. 4.

A polymer is a large molecule composed of repeating units, typically connected by covalent chemical bonds. A polymer is formed from monomers. During the formation of the polymer, some chemical groups can be lost from each monomer. The piece of the monomer that is incorporated into the polymer is known as the repeating unit or monomer residue. The backbone of the polymer is the continuous link between the monomer residues. The polymer can also contain functional groups connected to the backbone at various locations along the backbone. Polymer nomenclature is generally based upon the type of monomer residues comprising the polymer. A polymer formed from one type of monomer residue is called a homopolymer. A copolymer is formed from two or more different types of monomer residues. The number of repeating units of a polymer is referred to as the chain length of the polymer. The number of repeating units of a polymer can range from approximately 11 to greater than 10,000. In a copolymer, the repeating units from each of the monomer residues can be arranged in various manners along the polymer chain. For example, the repeating units can be random, alternating, periodic, or block. The conditions of the polymerization reaction can be adjusted to help control the average number of repeating units (the average chain length) of the polymer.

A polymer has an average molecular weight, which is directly related to the average chain length of the polymer. The average molecular weight of a polymer has an impact on some of the physical characteristics of a polymer, for example, its solubility and its dispersibility. For a copolymer, each of the monomers will be repeated a certain number of times (number of repeating units). The average molecular weight (M_{w}) for a copolymer can be expressed as follows:

M_{w}=ΣwₓMₓ

where wₓ is the weight fraction of molecules whose weight is Mₓ.

During polymerization of the polymer matrix, a plane of the nano sheets can align parallel to a longitudinal axis of the electromagnetic wire. This parallel alignment however, decreases heat flow through the filler composition in a direction away from the wire. Accordingly, the filler composition can further include a plurality of co-particles.

As shown in FIG. 2, the co-particles can be a nano powder that is bound to the surface of the fully oxidized graphene (or boron nitride) nano sheet. The co-particles can be surface modified in order to bond with the chemical groups on the surface of the nano sheet. Surface modification can occur by adsorption of amine groups or surface bonding of APTS (aminopropyltriethoxysilane) from the diamine stabilizer/first monomer. The oxidized graphene, graphene oxide, or boron nitride nano sheets can be coated with aminized AlN powder through amidization reactions between carboxylic acid and surface amine groups. The co-particles coated with the nano sheets can provide decreased electrical conductivity and also help increase thermal conductivity through the polymer matrix.

As shown in FIGS. 3 and 4, a first edge of partially oxidized graphene or boron nitride nano sheets is bound to the surface of the co-particle. The nano sheets do not have to chemically bond with the surfaces of the co-particles, but preferably form bonds and attach to the surfaces of the co-particles. The nano sheet-coated co-particles can form bridges between the nano sheets, which can increase heat conduction in a direction away from the wire.

The co-particles can be selected from the group consisting of BN, B₄C, AlN, Al₂O₃, SiO₂, MgO, SiC, Si₃N₄, ZnO, BeO, diamond, metal oxides, titanium oxide, quartz, ceramics, and combinations thereof. According to certain aspects, the co-particles are boron nitride powder or aluminum nitride powder. Aluminum nitride powder may not be used in applications with high moisture content in the area as aluminum nitride can easily react with water.

The co-particles can be three-dimensional particles having a variety of geometric shapes including, but not limited to, spherical, cubical, hexagonal, triangular, or combinations thereof. The co-particles can also have a mean cross-sectional particle size in the range of about 0.1 μm to about 10 μm. According to certain aspects, the co-particles are in a concentration in the range of about 1% to about 20% by volume of the composition.

The methods can further include performing a silane treatment on the dispersed fully or partially oxidized graphene or boron nitride nano sheets and the co-particles. A silane treatment can functionalize the edges of the nano sheets and the co-particles wherein the edges and surfaces are amino treated. The silane treatment can help the nano sheets bond to the surfaces of the co-particles. An illustrative silane treatment can include combining exfoliated boron nitride nano sheets (BNNS) dispersed in the polar organic solvent with aminopropyltriethoxysilane (APS) under protection of flowing nitrogen, so the BNNS edges are amino-treated. The solution can be stirred in a 3-necked flask, equipped with a reflux condenser and a magnetic stir bar. The stirring solution can be heated to approximately 120° C. for 4 hours. The silane treatment can also functionalize other edges of the exfoliated boron nitride nano sheets that are not attached to the co-particles for bonding with functional groups of the polymer matrix. In this manner, the nano sheets obtain proper alignment, dispersion, and bridging to provide improved thermal conductivity through the coating composition.

The filler composition also includes a thermal setting polymer matrix. According to certain aspects, the nano sheets and the optional co-particles are dispersed throughout the polymer matrix. The polymer matrix can also help stabilize and keep the nano sheets and optional co-particles suspended and separated within the matrix. The polymer matrix can be thermally conductive. The polymer can be a homopolymer or a co-polymer. The first monomer can be selected from 4,4′-methylenedianiline and methylene diphenyl diisocyanate. The second monomer can be selected from dicarboxylic acid, dicarboxylic acid anhydride, alkyl ester, and other dicarboxylic acid derivatives. Any of the polymers can include two or more monomers or monomer residues, cross-linking agents, and/or functional groups on the polymer. Suitable functional groups and/or cross-linking agents include, but are not limited to, ethers, epoxides, amides, esters, and combinations thereof.

According to certain aspects, the thermal setting polymer is thermally stable up to a temperature of 180° C. As used herein, the term “thermally stable” means that the polymer does not burn or degrade. According to this aspect, the thermal setting polymer is a polyimide, such as polyester imide (PEI) or poly(ester-imide-ether). As used herein, a “polyimide” refers to polymers comprising repeating imide functional groups, and optionally additional functional groups such as amides and/or ethers. PEI can be formed by polymerizing a first monomer of 4,4′-methylenedianiline, a second monomer of methyl trimellitic anhydride ester, and a third monomer of 4,4′-biphenol. The thermoplastic polymer can also be poly(ester-imide-ether) and formed by polymerizing dimethyl terephthalate (DMT) and N-(4-carbomethoxyphenyl)-4-(carbomethoxy)-phthalimide with ethylene glycol (EG) and polytetramethylene glycol (PTMG).

According to certain other aspects, the thermal setting polymer is thermally stable up to a temperature of 200° C. According to this aspect, the polymer is polyamide-imide (PAI), polysulfones, or combinations thereof. PAI can be formed via an acid chloride route wherein condensation of an aromatic diamine, such as methylene dianiline (MDA), and an aromatic diacid chloride, such as trimellitic acid chloride (TMAC), terephthaloyl chloride, isophthaloyl chloride, or naphthoyl chloride, occurs. Reaction of the anhydride with the diamine produces an intermediate amic acid. The acid chloride functional group reacts with the aromatic amine to give the amide bond and hydrochloric acid (HCl) as a by-product. PAI can also be formed via a diisocyanate route wherein a diisocyanate, such as 4,4′-methylene diphenyl diisocyanate (MDI), is reacted with trimellitic anhydride (TMA). Polysulfones can be formed by condensing a diphenol, such as bisphenol-A, biphenol, or dihydroxy diphenyl ether with a dihalide containing sulfone groups, such as bis(4-chlorophenyl sulfone) or bis(4-chlorophenyl)sulfone, which forms a polyether by elimination of sodium chloride.

According to certain other aspects, the thermal setting polymer is thermally stable at a temperature greater than or equal to 240° C. According to this aspect, the polymer is a polyimide (PI) or a polyether ketone. PI can be formed by polymerizing a first monomer of a dianhydride, such as pyromellitic dianhydride, benzoquinonetetracarboxylic dianhydride, bisphenol A dianhydride, naphthyl dianhydride, or biphenyl dianhydride with a second monomer of a diamine, such as 4,4′-diaminodiphenyl ether (“DAPE”), meta-phenylenediamine (“MDA”), and 3,3-diaminodiphenylmethane. PI can also be formed by polymerizing the dianhydride with a second monomer of a diisocyanate, such as 4,4′-methylene diphenyl diisocyanate (MDI). Polyether kemnes can be formed by step-growth polymerization by the dialkylation of bisphenolate salts, such as 4,4′-difluorobenzophenone with the disodium salt of hydroquinone. The polymerization can be carried out in a suitable polar aprotic solvent, such as diphenyl sulphone.

The methods include combining the first monomer and a second monomer (and optionally any other monomers) to form the thermal setting polymer. As discussed above, the first monomer can be combined with the graphene or boron nitride powder and solvent prior to, during, or after formation of the nano sheets. The second monomer (and any other monomers) can be combined with the first monomer after formation of the nano sheets or exfoliated nano sheets, for example, after a silane treatment, or during or after surface coupling of the nano sheets to the co-particles. The monomers form the polymer via in situ polymerization; thus, maintaining separation and dispersion of the fully or partially oxidized graphene or boron nitride nano sheets or the nano sheets/co-particles. The polymerization reaction can be controlled to provide a polymer with a desired molecular weight. The molecular weight of the polymer can be in the range of about 10,000 to about 100,000. The polymer can include linear or branched units and be arranged in random, alternating, periodic, or block configurations. Moreover, the ratio of the monomers can be selected to provide the desired thermal stability of the resulting polymer.

The filler composition has a thermal conductivity greater than or equal to 3 W/mK. According to certain aspects, the polymer has an electric breakdown voltage that is sufficiently high to prevent the polymer from burning or degrading during the spikes in electric current flowing through the wire. The monomers selected and other characteristics of the polymer, such as molecular weight can be selected such that the polymer has the sufficient electric breakdown voltage. According to certain other aspects, the filler composition also has an electric breakdown voltage greater than or equal to 20 kilovolts per millimeter (kV/mm). A voltage differential between the wire or the coated wire and the polymer matrix occurs when an electrical current passes through the electromagnetic wire and/or the coating of the wire. Accordingly, the polymer matrix should be able to withstand the voltage differential without burning or degrading. The polymer matrix can be electrically insulating (i.e., has an electrical conductivity less than or equal to 10 kV/mm) in order to inhibit or prevent movement of electrons through the polymer. The polymer's electrical conductivity and electric breakdown voltage are inversely related—the lower the conductivity, the higher the breakdown voltage.

The filler composition is pourable. As used herein, the term “pourable” means that the composition has a viscosity less than or equal to a sufficient viscosity such that the composition can be poured from a container prior to thermally setting or curing. Viscosity is a measure of the resistance of a fluid to flow, defined as the ratio of shear stress to shear rate. Viscosity can be expressed in units of (force*time)/area. For example, viscosity can be expressed in units of dyne*s/cm² (commonly referred to as Poise (P)), or expressed in units of Pascals/second (Pa/s). According to certain aspects, the filler composition has a viscosity prior to curing in the range from about 1 centipoise (cP) to about 10,000 cP.

The filler composition can further include an additive selected from the group consisting of primary antioxidants, secondary antioxidants, acid scavenger or neutralizer, UV absorbers/stabilizers, anti-blocking agents, slip agents, antistatic agents, antifogging agents, nucleating agents, coupling agents, cross-linking agents, controlled-cracking agents, flame retardants, lubricants, and combinations thereof.

The methods can further include applying the filler composition between an electromagnetic wire of an electromagnetic coil. As such, the filler composition surrounds and/or is located between the wound wire of the electromagnetic coil. The filler composition can be located only between the wound wire or between and on top of the wire. According to certain aspects, the pre-formed filler composition can be co-extruded with the wire to form a cladding layer on the wire. According to certain other aspects, liquid phase monomers or oligomers can be co-extruded with the co-particles on the wire to form a coating layer according to a reactive extrusion process.

The thermal setting polymer can cure and harden with time and temperature. The methods can further include causing or allowing the filler composition to thermally set after the step of applying. The time and temperature for curing can be selected for the specific polymer chosen for the thermoplastic polymer matrix.

The following are illustrated methods for preparing the fully or partially oxidized graphene or boron nitride nano sheets and co-particles. It is to be understood that while the following examples relate to boron nitride, graphene can also be used instead. The following examples are not the only methods for producing the filler composition and are not intended to limit the scope of the various aspects.

Formation of exfoliated boron nitride nano sheets (BNNS) can be produced as follows:
(A) boron nitride powder (BN)-oxidized-silanation—removal of un-partially exfoliated BN powder by centrifugation;
(B) BN-oxidized, silanation after exfoliation—removal of un-partially exfoliated BN powder by centrifugation;
(C) BN powder as received, oxidation, silanation after exfoliation—removal of un-partially exfoliated BN powder by centrifugation;
(D) BN-oxidized-silanation—no removal of un-partially exfoliated BN powder, resulting in mixed BNNS plus BN powder;
(E) BN-oxidized, silanation after exfoliation—no removal of un-partially exfoliated BN powder, resulting in mixed BNNS plus BN powder; and
(F) BN without treatment, oxidation, silanation after exfoliation—no removal of un-partially exfoliated BN powder, resulting in mixed BNNS plus BN powder.

Formation of the co-particles and BBNS to form a three-dimensional filler additive can be produced as follows:
(A) BN oxidize+silanation, exfoliate in absence of first monomer (e.g., diamine), centrifuge, BN powder oxidize+silanation, second monomer coupling;
(B) BN oxidize+silanation, exfoliate in absence of first monomer, without centrifugation, second monomer coupling with un-exfoliated BN powder;
(C) BN-oxidized-silanation—removal of un-partially exfoliated BN powder by centrifugation;
(D) BN-oxidized, silanation after exfoliation—removal of un-partially exfoliated BN powder by centrifugation;
(E) BN without treatment, oxidation, silanation after exfoliation—removal of un-partially exfoliated BN powder by centrifugation;
(F) BN-oxidized-silanation—no removal of un-partially exfoliated BN powder, resulting in mixed BNNS plus BN powder;
(G) BN-oxidized, silanation after exfoliation—no removal of un-partially exfoliated BN powder, resulting in mixed BNNS plus BN powder; and
(H) BN without treatment, oxidation, silanation after exfoliation—no removal of un-partially exfoliated BN powder, resulting in mixed BNNS plus BN powder.

Therefore, the present disclosure is well adapted to attain the ends and advantages mentioned as well as those that are inherent therein. The particular aspects disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative aspects disclosed above may be altered or modified and all such variations are considered within the scope and spirit of the present disclosure.

As used herein, the words “comprise,” “have,” “include,” and all grammatical variations thereof are each intended to have an open, non-limiting meaning that does not exclude additional elements or steps. While compositions, systems, and methods are described in terms of “comprising,” “containing,” or “including” various components or steps, the compositions, systems, and methods also can “consist essentially of” or “consist of” the various components and steps. It should also be understood that, as used herein, “first,” “second,” and “third,” are assigned arbitrarily and are merely intended to differentiate between two or more phases, etc., as the case may be, and does not indicate any sequence. Furthermore, it is to be understood that the mere use of the word “first” does not require that there be any “second,” and the mere use of the word “second” does not require that there be any “third,” etc.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

Various combinations of elements of this disclosure are encompassed by this disclosure, e.g., combinations of elements from dependent claims that depend upon the same independent claim.

### Aspects of the Disclosure

In various aspects, the present disclosure pertains to and includes at least the following aspects.

Aspect 1. A filler composition comprising:
fully or partially oxidized graphene or boron nitride nano sheets; and
a thermal setting polymer matrix, wherein the fully or partially oxidized graphene or boron nitride nano sheets are embedded within the polymer matrix, and wherein the filler composition:
   (i) has a thermal conductivity greater than or equal to 3 W/mK;
   (ii) has an electric breakdown voltage greater than or equal to 10 kV/mm;
   (iii) is pourable; and
   (iv) is located between an electromagnetic wire of an electromagnetic coil.

Aspect 2. The filler composition according to Aspect 1, wherein the fully or partially oxidized graphene or boron nitride nano sheets are in a concentration in a range of about 1% to about 25% by volume of the filler composition.

Aspect 3. The filler composition according to Aspect 1 or 2, further comprising a plurality of co-particles, wherein a first edge of the fully or partially oxidized graphene or boron nitride nano sheets are bound to surfaces of the co-particles.

Aspect 4. The filler composition according to Aspect 3, wherein the co-particles are selected from the group consisting of BN, B₄C, AlN, Al₂O₃, SiO₂, MgO, SiC, Si₃N₄, ZnO, BeO, diamond, metal oxides, titanium oxide, quartz, ceramics, and combinations thereof.

Aspect 5. The filler composition according to Aspect 3, wherein the co-particles are BN.

Aspect 6. The filler composition according to Aspect 3, wherein the co-particles are in a concentration in a range of about 1% to about 20% by volume of the filler composition.

Aspect 7. The filler composition according to any of Aspects 1 to 6, wherein the thermal setting polymer matrix is thermally stable up to a temperature of 180° C.

Aspect 8. The filler composition according to Aspect 7, wherein the thermal setting polymer matrix is polyester imide.

Aspect 9. The filler composition according to any of Aspects 1 to 8, wherein the thermal setting polymer matrix is thermally stable up to a temperature of 200° C.

Aspect 10. The filler composition according to Aspect 9, wherein the thermal setting polymer matrix is polyamide-imide, polysulfones, or combinations thereof.

Aspect 11. The filler composition according to any of Aspects 1 to 10, wherein the thermal setting polymer matrix is thermally stable at a temperature greater than or equal to 240° C.

Aspect 12. The filler composition according to Aspect 11, wherein the thermal setting polymer matrix is a polyimide or a polyether ketone.

Aspect 13. The filler composition according to any of Aspects 1 to 12, wherein the filler composition has a viscosity prior to curing in a range from about 1 to about 10,000 cP.

Aspect 14. A method of forming a filler composition comprising:
forming fully or partially oxidized graphene or boron nitride nano sheets;
combining a first monomer and a second monomer to form a thermal setting polymer matrix;
causing or allowing the fully or partially oxidized graphene or boron nitride nano sheets to be dispersed throughout the thermal setting polymer matrix, wherein the composition:
   (i) has a thermal conductivity greater than or equal to 3 W/mK;
   (ii) has an electric breakdown voltage greater than or equal to 10 kV/mm; and
   (iii) is pourable; and
applying the filler composition between an electromagnetic wire of an electromagnetic coil.

Aspect 15. The method according to Aspect 14, further comprising oxidizing a surface of graphene or boron nitride powder to form surface oxidized graphene or boron nitride powder prior to the step of forming the fully or partially oxidized graphene or boron nitride nano sheets.

Aspect 16. The method according to Aspect 15, further comprising:
adding the surface oxidized graphene or boron nitride powder to the first monomer and a solvent;
then forming the fully or partially oxidized graphene or boron nitride nano sheets and performing a silane treatment on the nano sheets and the first monomer; and
then combining the second monomer with the nano sheets and first monomer.

Aspect 17. The method according to Aspect 16, further comprising adding a plurality of co-particles after the step of combining the second monomer with the nano sheets and the first monomer, and allowing the nano sheets to bond to surfaces of the plurality of co-particles to form a filler additive.

Aspect 18. The method according Aspect 17, wherein the fully or partially oxidized graphene or boron nitride nano sheets are exfoliated prior to the step of performing a silane treatment on the nano sheets and the first monomer.

Aspect 19. The method according to any of Aspects 14 to 18, further comprising adding a plurality of co-particles before the step of combining the second monomer with first monomer, and allowing the fully or partially oxidized graphene or boron nitride nano sheets to bond to surfaces of the plurality of co-particles to form a filler additive.

Aspect 20. The method according to any of Aspects 14 to 19, wherein the electromagnetic wire is coated with a coating.

Aspect 21. The method according to any of Aspects 14 to 20, further comprising allowing the filler composition to thermally cure after the step of applying.

1-20. (canceled)

21. An electromagnetic coil comprising:
a coiled electromagnetic wire comprising a plurality of coils; and
a filler composition located between the plurality of coils, the filler composition comprising
fully or partially oxidized graphene or boron nitride nano sheets,
a thermal setting polymer matrix, and
a plurality of co-particles, wherein a first edge of the fully or partially oxidized graphene or boron nitride nano sheets are bound to surfaces of the co-particles, wherein
the fully or partially oxidized graphene or boron nitride nano sheets are embedded within the polymer matrix, and
the co-particles are selected from the group consisting of BN, B₄C, AlN, Al₂O₃, SiO₂, MgO, SiC, Si₃N₄, ZnO, BeO, diamond, metal oxides, titanium oxide, quartz, ceramics, and combinations thereof.

22. The filler composition according to claim 21, wherein the fully or partially oxidized graphene or boron nitride nano sheets are in a concentration in a range of about 1% to about 25% by volume of the filler composition.

23. The filler composition according to claim 21, wherein the co-particles comprise BN.

24. The filler composition according to claim 21, wherein the co-particles are in a concentration in a range of about 1% to about 20% by volume of the filler composition.

25. The filler composition according to claim 21, wherein the thermal setting polymer matrix is thermally stable up to a temperature of 180° C.

26. The filler composition according to claim 25, wherein the thermal setting polymer matrix comprises polyester imide.

27. The filler composition according to claim 21, wherein the thermal setting polymer matrix is thermally stable up to a temperature of 200° C.

28. The filler composition according to claim 27, wherein the thermal setting polymer matrix comprises polyamide-imide, polysulfones, or combinations thereof.

29. The filler composition according to claim 21, wherein the thermal setting polymer matrix is thermally stable up to a temperature of 240° C.

30. The filler composition according to claim 29, wherein the thermal setting polymer matrix is a polyimide or a polyether ketone.

31. The filler composition according to claim 21, wherein the filler composition has a viscosity prior to curing in a range from about 1 to about 10,000 cP.

32. A method of forming an electromagnetic coil comprising:
coiling an electromagnetic wire to form a plurality of coils;
forming a filler composition comprising
forming fully or partially oxidized graphene or boron nitride nano sheets;
combining a first monomer and a second monomer to form a thermal setting polymer matrix;
adding a plurality of co-particles and allowing the nano sheets to bond to surfaces of the plurality of co-particles to form a filler additive, wherein the plurality of co-particles are selected from the group consisting of BN, B₄C, AlN, Al₂O₃, SiO₂, MgO, SiC, Si₃N₄, ZnO, BeO, diamond, metal oxides, titanium oxide, quartz, ceramics, and combinations thereof;
causing or allowing the fully or partially oxidized graphene or boron nitride nano sheets to be dispersed throughout the thermal setting polymer matrix; and
applying the filler composition between the plurality of coils.

33. The method according to claim 32, further comprising oxidizing a surface of graphene or boron nitride powder to form surface oxidized graphene or boron nitride powder prior to the step of forming the fully or partially oxidized graphene or boron nitride nano sheets.

34. The method according to claim 33, further comprising:
adding the surface oxidized graphene or boron nitride powder to the first monomer and a solvent;
then forming the fully or partially oxidized graphene or boron nitride nano sheets and performing a silane treatment on the nano sheets and the first monomer; and
then combining the second monomer with the nano sheets and first monomer.

35. The method according to claim 34, further comprising adding a plurality of co-particles after the step of combining the second monomer with the nano sheets and the first monomer, and allowing the nano sheets to bond to surfaces of the plurality of co-particles to form a filler additive.

36. The method according claim 35, wherein the fully or partially oxidized graphene or boron nitride nano sheets are exfoliated prior to the step of performing a silane treatment on the nano sheets and the first monomer.

37. The method according to claim 32, further comprising adding a plurality of co-particles before the step of combining the second monomer with first monomer, and allowing the fully or partially oxidized graphene or boron nitride nano sheets to bond to surfaces of the plurality of co-particles to form a filler additive.

38. The method according to claim 32, further comprising allowing the filler composition to thermally cure after the step of applying the filler composition between the plurality of coils.
